(19) United States
(12) Patent Application Publication
(10) Pub. No.: US 2022/0020231 A1
(43) Pub. Date: Jan. 20, 2022

(54) PHYSICAL QUANTITY MEASUREMENT METHOD, MEASUREMENT SYSTEM, HOST SYSTEM, AND SENSING APPARATUS

(71) Applicant: SEIKO EPSON CORPORATION, Tokyo (JP)

(72) Inventors: Kazuyoshi Takeda, Chino-shi (JP); Keishi Omori, Matsumoto-shi (JP)

(21) Appl. No.: 17/378,827

(22) Filed: Jul. 19, 2021

(30) Foreign Application Priority Data
Jul. 20, 2020 (JP) 2020-123518

(51) Int. Cl. G07C 5/08; G01P 15/18; G07C 5/00

(52) U.S. Cl. CPC G07C 5/0808; G07C 3/00; G07C 5/008; G01P 15/18

(57) ABSTRACT

A physical quantity measurement method acquires a plurality of measurement results corresponding to the passage of a plurality of vehicles based on the measurement performed by a sensor for physical quantity computation attached to a structure through which the plurality of vehicles pass. The physical quantity measurement method further identifies the vehicle corresponding to each of the plurality of measurement results based on measurement time information that is information on the time when the measurement is performed and operation information that is information on the operation status of the vehicle. The physical quantity measurement method then determines whether or not to use each of the plurality of measurement results in an abnormality evaluation process of evaluating abnormality of the structure based on a vehicle identification result that is the result of the identification of the vehicle.

The present application is based on, and claims priority from JP Application Serial Number 2020-123518, filed Jul. 20, 2020, the disclosure of which is hereby incorporated by reference herein in its entirety.

### BACKGROUND

### 1. Technical Field

The present disclosure relates to a physical quantity measurement method, a measurement system, a host system, a sensing apparatus, and the like.

### 2. Related Art

There is a known approach of related art for placing a sensing apparatus in a structure, such as a tunnel and collecting data detected with a sensor provided in the sensing apparatus via a network. The sensor measures a physical quantity, such as acceleration, when time determined in advance is reached. Accumulating data provided by the measurement allows diagnosis of the degree of damage or deterioration of the structure and prediction of the future situation of the structure.

To improve the accuracy of the diagnosis and prediction described above, it is desirable to associate the measured data with the type of a vehicle which has passed through the structure and from which the measured data results. It is not preferable to install a camera or any other device in the vicinity of the structure in order to obtain information on the vehicle passing through the structure because the installation is costly and time-consuming. JP-A-2015-102329 discloses an approach for estimating the speed of a train from the predominant frequency that is the measurement result from the sensor and further estimating the type of cars based on the information on the length and formation of the cars.

The type of the cars may, however, not be correctly identified simply by estimating the speed of the cars only from the measurement result from the sensor. There is information for identification of the cars, such as a train timetable, but the cars cannot always be operated on time as stated in the timetable due to traffic conditions. The approach disclosed in JP-A-2015-102329 does not consider such a case.

### SUMMARY

An aspect of the present disclosure relates to a physical quantity measurement method including acquiring a plurality of measurement results corresponding to passage of a plurality of vehicles based on measurement performed by a sensor for physical quantity computation attached to a structure through which the plurality of vehicles pass, identifying the vehicle corresponding to each of the plurality of measurement results based on measurement time information that is information on time when the measurement is performed and operation information that is information on an operation status of the vehicle, and determining whether or not to use each of the plurality of measurement results in an abnormality evaluation process of evaluating abnormality of the structure based on a vehicle identification result that is a result of the identification of the vehicle.

Another aspect of the present disclosure relates to a measurement system including a measurement section that acquires a plurality of measurement results corresponding to passage of a plurality of vehicles based on measurement performed by a sensor for physical quantity computation attached to a structure through which the plurality of vehicles pass and a determination section that identifies the vehicle corresponding to each of the plurality of measurement results based on measurement time information that represents time when the measurement result is obtained and operation information that is information on an operation status of the vehicle and determines whether or not to use each of the plurality of measurement results in an abnormality evaluation process of evaluating abnormality of the structure based on a vehicle identification result that is a result of the identification of the vehicle.

Another aspect of the present disclosure relates to a host system including a communication interface that communicates with a sensing apparatus and a processor. The sensing apparatus acquires a plurality of measurement results corresponding to passage of a plurality of vehicles based on measurement performed by a sensor for physical quantity computation attached to a structure through which the plurality of vehicles pass. The communication interface receives information that associates each of the measurement results with measurement time information representing time when the measurement result is obtained. The processor identifies the vehicle corresponding to each of the plurality of measurement results based on the measurement time information and operation information that is information on an operation status of the vehicle and determines whether or not to use each of the plurality of measurement results in an abnormality evaluation process of evaluating abnormality of the structure based on a vehicle identification result that is a result of the identification of the vehicle.

Another aspect of the present disclosure relates to a sensing apparatus including a sensor for physical quantity computation attached to a structure through which a plurality of vehicles pass, a processing circuit, and a communication circuit that receives operation information representing an operation status of each of the vehicles from a host system. The processing circuit acquires a plurality of measurement results corresponding to passage of the plurality of vehicles based on measurement performed by the sensor, identifies the vehicle corresponding to each of the plurality of measurement results based on measurement time information representing time when the measurement result is obtained and operation information that is information on an operation status of the vehicle, and determines whether or not to use each of the plurality of measurement results in an abnormality evaluation process of evaluating abnormality of the structure based on a vehicle identification result that is a result of the identification of the vehicle. The communication circuit transmits the measurement result determined to be used in the abnormality evaluation process to the host system.

### BRIEF DESCRIPTION OF THE DRAWINGS

FIG. 1 is a block diagram showing an example of the configuration of a measurement system.

FIG. 2 describes an example of the configuration of a sensing system.

FIG. 3 is a block diagram showing an example of the configuration of a sensing apparatus.

FIG. 4 is a block diagram showing an example of the configuration of a host system.

FIG. 5 describes an application example of the sensing apparatus.

FIG. 6 describes intermittent operation of the sensing apparatus.

FIG. 7 describes the procedure of a measurement process.

FIG. 8 describes the procedure of an initialization process.

FIG. 9 is a flowchart for describing an example of how to carry out an abnormality evaluation process.

FIG. 10 is a flowchart for describing an example of how to carry out a measurement result analysis process.

FIG. 11 is a flowchart for describing an example of how to carry out a vehicle type identification process.

FIG. 12 describes vehicle information and operation information.

FIG. 13 describes the vehicle information and scheduled operation information.

FIG. 14 describes a timing at which time synchronization is performed before the start of the measurement.

FIG. 15 describes the procedure of processes in a operating status monitoring period.

FIG. 16 is a flowchart for describing a variation of a computation process.

### DESCRIPTION OF EXEMPLARY EMBODIMENTS

A preferable embodiment of the present disclosure will be described below in detail. It is not intended that the present embodiment described below unduly limits the contents set forth in the appended claims, and all configurations described in the present embodiment are not necessarily essential configuration requirements.

### 1. Measurement System

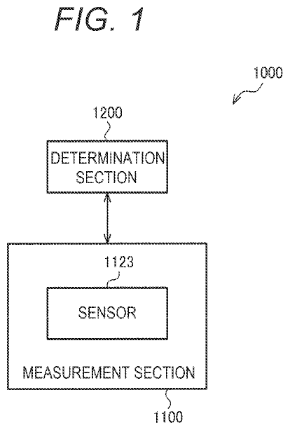

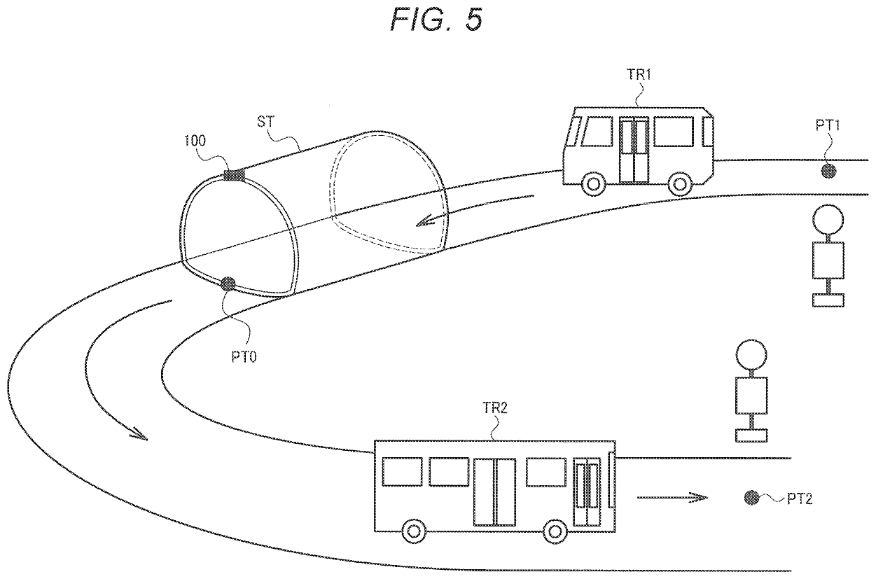

FIG. 1 is a block diagram showing an example of the configuration of a measurement system 1000 relating to a physical quantity measurement method according to the present embodiment. The measurement system 1000 includes a measurement section 1100 and a determination section 1200, and the measurement section 1100 includes a sensor 1123. The number of sensors 1123 is not limited to one, and the sensor 1123 may be formed of a plurality of sensors 1123. The sensor 1123 in the present embodiment is a sensor for physical quantity computation and can be achieved by the same configuration as that of a sensor 123 described later. The sensor 1123 is attached, for example, to a structure ST, through which a plurality of vehicles TR pass, and performs measurement for a predetermined period, as will be described later with reference to FIG. 5. The measurement will be described later in detail. In the following description, the vehicles are distinguished from each other, that is, a first type vehicle TR1, a second type vehicle TR2, and a third type vehicle TR3 in some cases or simply called vehicles TR in other cases.

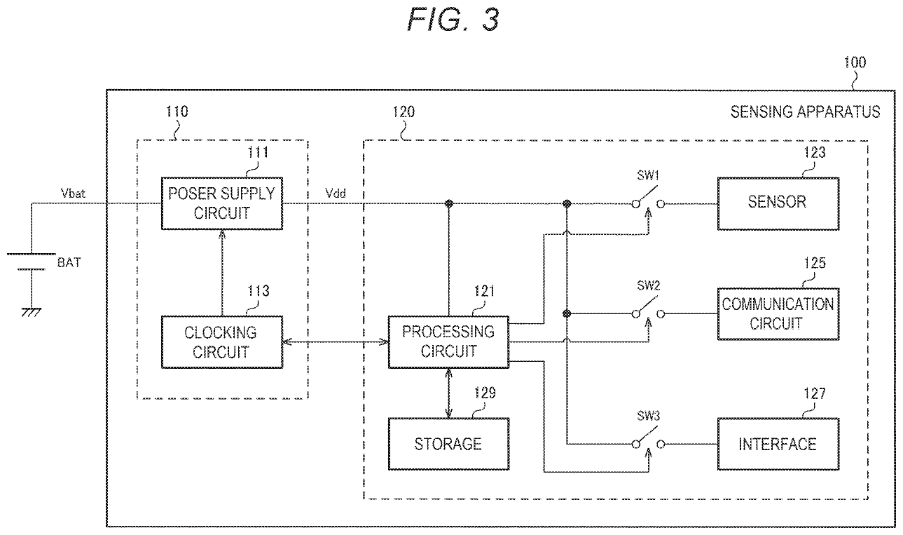

The measurement section 1100 acquires a plurality of measurement results corresponding to the passage of the plurality of vehicles TR based on the measurement performed by the sensor 1123 described above. The measurement section 1100 then uses a predetermined communication method to transmit the acquired measurement results along with measurement time information representing the points of time when the measurement is performed to the determination section 1200. When the sensor 1123 performs the measurement multiple times in a predetermined period, the sensor 1123 may transmit all the plurality of acquired measurement results or only selected necessary measurement results to the determination section 1200. The transmission performed by the sensor 1123 will be described later in detail. The case where the measurement is performed multiple times may be a case where the plurality of vehicles TR each pass through the structure ST once, a case where one vehicle TR makes a round trip so as to pass through the structure ST multiple times, or the combination of the two cases. The predetermined communication method will be described later. The measurement section 1100 can be achieved, for example, by the hardware that forms a processing circuit 121 in FIG. 3, which will be described later.

As described above, the measurement system 1000, which includes the measurement section 1100, can regularly measure a physical quantity of the structure ST. Accumulating measurement data relating to the measurement allows dynamic diagnosis of occurrence of damage or deterioration of the structure ST, the degree thereof, and prediction of the future situation thereof. Such a technology for evaluating the soundness of the structure ST can also be called structural health monitoring.

In the structural health monitoring, to improve the accuracy of the evaluation of the soundness of the structure ST, it is desirable to regularly accumulate the measurement data generated by the same factor, but all measurement data relating to the structure ST do not need to be accumulated. For example, when the vehicles TR pass by the vicinity of the structure ST, regularly accumulating the measurement data generated by the passage of the vehicles TR having the same weight leads to improvement in the accuracy of the evaluation of the soundness of the structure ST. Therefore, in evaluating whether to accumulate the measured data, it is desirable that the measurement data contains information on the vehicles TR. It is noted that the term “the same” used herein includes “substantially the same”, and the same interpretation holds true in the following description.

However, introducing a camera or any other device separately to identify the vehicles TR leads to an increase in cost and management burden. It is conceivable to employ an approach using information from an operation timetable, but the vehicles TR cannot always be operated on time as stated in the timetable due to traffic conditions, and there is a possibility of use of information on an incorrect vehicle TR. The approach disclosed in JP-A-2015-102329 does not consider such a case.

To handle such a case, the measurement system 1000 according to the present embodiment further includes the determination section 1200. The determination section 1200 identifies, based on a measurement result and measurement time information transmitted from the measurement section 1100, the vehicle TR under the measurement. Specifically, the determination section 1200 identifies the vehicle TR relating to the measurement result by comparing operation information acquired from a predetermined operation information database with the measurement time information. A specific identification method will be described later. The determination section 1200 can be achieved, for example, by the hardware that forms a processor 220, which will be described later. The determination section 1200 then determines whether or not the transmitted measurement result is used in an abnormality evaluation process of evaluating abnormality of the structure ST based on a vehicle identification result that is the result of the identification of the vehicle TR. The abnormality evaluation process of evaluating abnormality of the structure ST is a process relating to the structural health monitoring of the structure ST and will be described later in detail. Further, in the following description, the abnormality evaluation process of evaluating abnormality of the structure ST is simply referred to as an abnormality evaluation process in some cases. When a plurality of measurement results are transmitted to the determination section 1200, the determination section 1200 determines whether or not to use each of the plurality of measurement results in the abnormality evaluation process of evaluating abnormality of the structure ST. A specific determination method will be described later.

In other words, the physical quantity measurement method according to the present embodiment acquires a plurality of measurement results corresponding to the passage of the plurality of vehicles TR based on the measurement performed by a sensor 123 for physical quantity computation, which is attached to the structure ST, through which the plurality of vehicles TR pass. Further, the physical quantity measurement method identifies the vehicle TR corresponding to each of the plurality of measurement results based on the measurement time information, which is the information on the time when the measurement is performed, and the operation information, which is the information on the operation status of the vehicle TR. The physical quantity measurement method then determines whether or not to use each of the plurality of measurement results in the abnormality evaluation process of evaluating abnormality of the structure ST based on the vehicle identification result, which is the result of the identification of the vehicle TR.

As described above, the physical quantity measurement method and the measurement system 1000 according to the present embodiment, which include the measurement section 1100 and the determination section 1200 described above, can exclude measurement results that are not suitable for the abnormality evaluation process of evaluating abnormality of the structure ST and can therefore improve the accuracy of evaluation of the soundness of the structure ST evaluated by the abnormality evaluation process. It is not necessary to identify the vehicle TR corresponding to each of the plurality of measurement results, and the vehicles TR corresponding to some of the measurement results may not be identified. Similarly, it is not necessary to determine whether or not to use each of the plurality of measurement results in the abnormality evaluation process.

The measurement system 1000 according to the present embodiment can be embodied in a variety of variations, for example, by adding another component. For example, although not shown, an abnormality evaluation processing section that carries out the abnormality evaluation process described later may be provided.

### 2. Example of Application to Sensing System

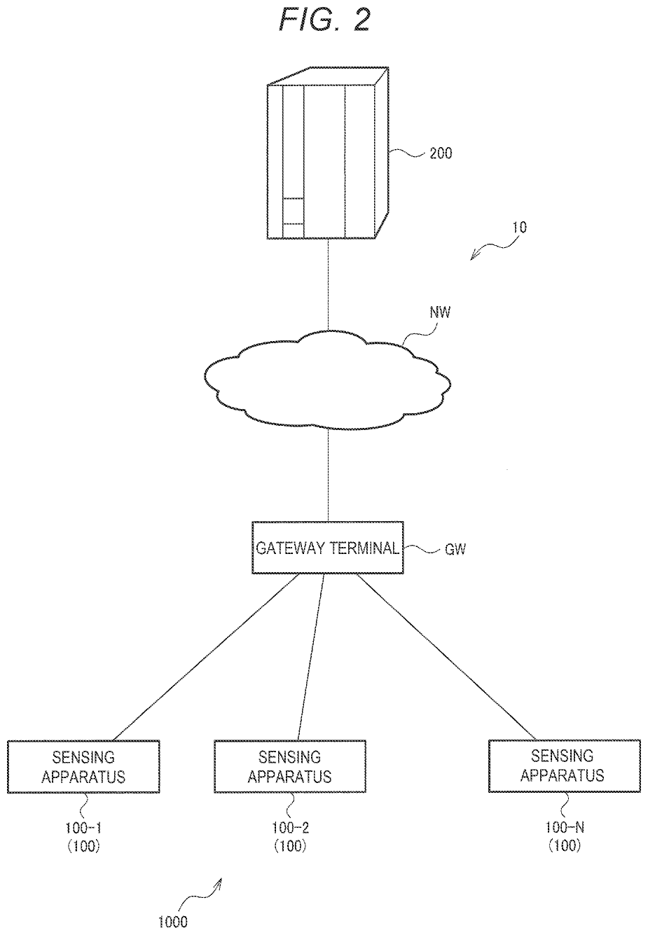

To specifically achieve the physical quantity measurement method and the measurement system 1000 according to the present embodiment, an example of application to a sensing system 10 will next be described. FIG. 2 describes an example of the configuration of the sensing system 10. The measurement section 1100 in FIG. 1 corresponds to sensing apparatuses 100 in FIG. 2, the determination section 1200 in FIG. 1 corresponds to a host system 200 of FIG. 2, and the sensor 1123 in FIG. 1 corresponds to the sensor 123 in FIG. 3, which will be described later. FIG. 2 shows N sensing apparatuses 100, and the sensing system 10 includes a sensing apparatus 100-1, a sensing apparatus 100-2, . . . , and a sensing apparatus 100-N. N is an integer greater than or equal to two. The correspondence between FIGS. 1 and 2 is not limited to that described above. For example, the sensing apparatuses 100 may correspond to both the measurement section 1100 and the determination section 1200, and such a correspondence will be described later with reference to a variation.

The sensing apparatuses 100 each include the sensor 123 as shown in FIG. 3, which will be described later, and the sensor 123 outputs sensor output information. The sensing apparatuses 100 each transmit transmission information based on the sensor output information to the host system 200 as the measurement result via a network NW. The sensing apparatuses 100 will be described later in detail with reference to FIG. 3.

The sensing apparatuses 100 are coupled to a gateway terminal GW. Communication between the sensing apparatuses 100 and the gateway terminal GW is performed, for example, by using LPWA (low power wide area). A variety of schemes, such as LoRaWAN (registered trademark), Sigfox (registered trademark), and NB-IoT, are known as LPWA, and any of the schemes can be applied in the present embodiment. For example, the gateway terminal GW is a base station that relays the communication and functions as an Internet gateway. The sensing apparatuses 100 and the host system 200 use the gateway terminal GW to perform the communication via the network NW. The network NW in the description is, for example, a public wireless communication network, such as the Internet, and use of a private network or any other network is not inhibited. In the present embodiment, the sensing apparatuses 100 and the host system 200 only need to be capable of performing the communication via the network NW, and the specific configuration of the sensing system 10 is not limited to the configuration shown in FIG. 2.

FIG. 3 is a block diagram showing an example of the configuration of each of the sensing apparatuses 100. The sensing apparatuses 100 each include a power supply circuit 111, a clocking circuit 113, the processing circuit 121, the sensor 123, and a communication circuit 125. The sensing apparatuses 100 may each further include an interface 127 and a storage 129. However, the sensing apparatuses 100 do not each necessarily have the configuration shown in FIG. 3, and a variety of variations are conceivable, for example, part of the components is omitted, or another component is added.

The power supply circuit 111 is a circuit that outputs, when a battery BAT supplies the power supply circuit 111 with battery voltage Vbat, power supply voltage Vdd based on the battery voltage Vbat. In the following description, the battery voltage is simply referred to as Vbat, and the power supply voltage outputted by the power supply circuit 111 is simply referred to as Vdd. The power supply circuit 111 is, for example, a regulator and is in a narrow sense an LDO (low dropout). For example, Vbat ranges from 7 to 8 V, and Vdd is 3.3 V. The voltage values of Vbat and Vdd are, however, not limited to those described above and can be changed in a variety of manners.

The clocking circuit 113 is a circuit that measures time, for example, an RTC (real-time clock). The clocking circuit 113 outputs time information. The time information used herein is information that specifies, for example, a year, a month, a day, an hour, a minute, and a second. The time information may further include information on a day of the week. The clocking circuit 113 includes an oscillation circuit that outputs a clock signal having a predetermined frequency based on an oscillator. The clocking circuit 113 generates, for example, a 1-Hz clock signal by dividing the clock signal outputted by the oscillation circuit and updates the time information described above in synchronization with the 1-Hz clock signal. Circuits having a variety of configurations are known as the RTC, and any of the circuits can be used in the present embodiment.

The processing circuit 121 operates based on Vdd from the power supply circuit 111. The processing circuit 121 acquires the sensor output information from the sensor 123 by controlling the sensor 123. The processing circuit 121 carries out the process of computing a measurement result based on the sensor output information. The computation process will be described later in details. Further, the processing circuit 121 carries out the process of associating the output information from the sensor with the time information from the clocking circuit 113 as the measurement time. The processing circuit 121 carries out the process of transmitting the measurement result to the host system 200 by controlling the communication circuit 125. Further, the processing circuit 121 transmits and receives information to and from an external apparatus by controlling the interface 127.

Specifically, the processing circuit 121 performs on/off control of the operation of the sensor 123 by controlling a switch element SW1. The processing circuit 121 further performs on/off control of the operation of the communication circuit 125 by controlling a switch element SW2. The processing circuit 121 may further perform on/off control of the operation of the interface 127 by controlling a switch element SW3. The switch elements SW1 to SW3 are each achieved by a transistor, for example, an FET (field effect transistor) and may instead be formed of a switch having another configuration.

The processing circuit 121 in the present embodiment is formed of the hardware described below. The hardware can include at least one of a circuit that processes a digital signal and a circuit that processes an analog signal. For example, the hardware can be formed of one or more circuit apparatuses or one or more circuit elements mounted on a circuit substrate. The one or more circuit apparatuses are, for example, an IC (integrated circuit), an FPGA (field-programmable gate array), and other components. The one or more circuit elements are, for example, a resistor, a capacitor, and other elements. The processor 220, which will be described later, can also be achieved by the same hardware.

The processing circuit 121 may instead be achieved by the processor described below. The sensing apparatuses 100 in the present embodiment each include a memory that stores information and a processor that operates based on the information stored in the memory. The memory is, for example, the storage 129. The information is, for example, a program and a variety of data. The processor includes hardware. The processor is, for example, an MCU (microcontroller unit) or an MPU (microprocessor unit) . The processor may, for example, be a CPU (central processing unit) , a GPU (graphics processing unit), or a DSP (digital signal processor) . The memory may be a semiconductor memory, such as an SRAM (static random access memory) and a DRAM (dynamic random access memory) , a register, a magnetic storage apparatus, such as a hard disk drive, or an optical storage apparatus, such as an optical disk apparatus. For example, the memory stores a computer readable instruction, and when the processor executes the instruction, the corresponding function of the processing circuit 121 is achieved in the form of a process. The instruction used herein may be an instruction in an instruction set that forms the program or an instruction that instructs a hardware circuit of the processor to operate in a certain manner. The processor 220, which will be described later, can also be similarly achieved in the form of the combination of the above processor and a memory 230, which is a memory.

The sensor 123 is attached to the structure ST, through which the plurality of vehicles TR pass, as will be described later, for example, in FIG. 5. The sensor 123 is a sensor for physical quantity computation, performs measurement for a predetermined period, and outputs the sensor output information as the result of detection. The physical quantity is, for example, acceleration, and may instead be another physical quantity that can be computed into displacement. The sensor 123 is, for example, a three-axis acceleration sensor. In this case, the sensor output information is information containing data on acceleration in each of the three axes. The sensor 123 may instead be a six-axis sensor including a three-axis acceleration sensor and a three-axis gyro sensor. In this case, the sensor output information is information containing data on acceleration in each of the three axes and data on angular velocity around each of the axes. The sensor 123 may still instead be an inclination sensor that detects inclination of a target object or may be a vibration sensor that detects vibration of the target object. The sensor 123 may still instead be a temperature sensor that detects the temperature of the target object or the ambient temperature around the target object. In addition to the above, the sensor 123 in the present embodiment can be extended to a variety of other sensors capable of detecting the state of the target object.

The communication circuit 125 is a circuit that performs communication for transmitting the measurement result to the host system 200. In the example shown in FIG. 3, the communication circuit 125 is a wireless communication chip or a wireless communication module that performs communication in compliance with the LPWA standard. As described above, the configuration that allows the sensing apparatuses 100 and the host system 200 to communicate with each other is not limited to the configuration shown in FIG. 2, and the communication circuit 125 may include a wireless communication chip or a wireless communication module that performs communication in compliance with a standard other than the LPWA standard.

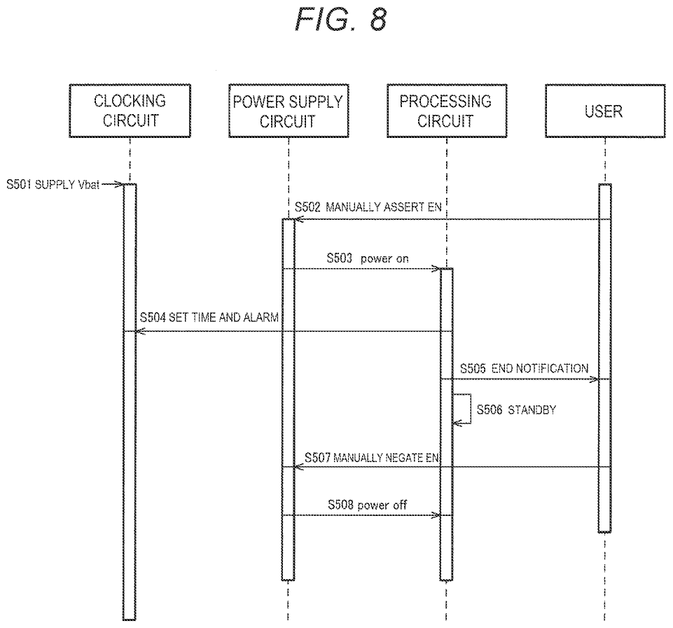

The interface 127 is a communication interface between the sensing apparatuses 100 and an external information processing apparatus. The interface 127 may be a UART (universal asynchronous receiver/transmitter) or another interface. For example, the interface 127 maybe an SPI (serial peripheral interface) or an I2C (inter-integrated circuit). The interface 127 is used, for example, in an initialization process described later with reference to FIG. 8. Although will be described later in detail with reference to a variation, the interface 127 may communicate with the operation information database.

The storage 129 stores a variety of pieces of information, such as data and programs, and the information may include, for example, vehicle information and scheduled operation time information described later. The processing circuit 121 operates, for example, by using the storage 129 as a work area. The storage 129 maybe an EEPROM (electrically erasable programmable read-only memory) or a flash memory, such as a MONOS (metal-oxide-nitride-oxide-silicon) memory. The storage 129 may be a semiconductor memory, such as an SRAM and a DRAM, a register, a magnetic storage apparatus, or an optical storage apparatus.

The sensing apparatuses 100 in the present embodiment each include a first circuit 110, which operates based on Vbat, and a second circuit 120, which operates based on Vdd, as shown in FIG. 3. The first circuit 110 includes the power supply circuit 111 and the clocking circuit 113. The second circuit 120 includes the processing circuit 121, the sensor 123, the communication circuit 125, the interface 127, and the storage 129. When the power supply circuit 111 stops outputting Vdd, each portion provided in the second circuit 120 stops operating. More specifically, when Vdd is not supplied, the processing circuit 121 does not operate, so that the sensor 123 or the communication circuit 125 controlled by the processing circuit 121 also does not operate. The power supply circuit 111 can stop supplying Vdd to efficiently reduce the power consumed by the sensing apparatuses 100.

For example, the power supply circuit 111 is a circuit that operates when an enable signal is asserted and stops operating when the enable signal is negated. The enable signal is controlled based on an alarm output from the clocking circuit 113. Specifically, the power supply circuit 111 is enabled when the alarm output from the clocking circuit 113 is on, and the power supply circuit 111 is disabled when the alarm output is off. The thus configured power supply circuit 111 can control whether or not Vdd is outputted, that is, the operation of each portion provided in the second circuit 120 based on the alarm output from the clocking circuit 113.

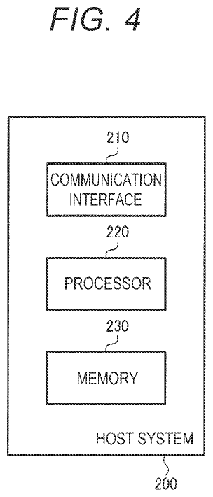

The host system 200 will next be described. FIG. 4 is a block diagram showing an example of the configuration of the host system 200. The host system 200 includes a communication interface 210 and the processor 220. The host system 200 may further include a memory 230, as shown in FIG. 4.

The host system 200 is a system that manages the plurality of sensing apparatuses 100. The host system 200 manages, for example, measurement start time when the sensing apparatuses 100 each start the measurement and communication start time when the sensing apparatuses 100 each start communicating the measurement results. Further, the host system 200 acquires the measurement results, the measurement time information, and other pieces of information from the plurality of sensing apparatuses 100.

The host system 200 can be achieved, for example, by a server system. The host system 200 may be formed of one server or may include a plurality of servers. The functions of the host system 200 may be achieved by distribution processing performed by a plurality of apparatuses coupled to each other via a network. In this case, the plurality of apparatuses may each operate as one physical server or as one or more virtual servers. For example, the host system 200 is a cloud system, and the specific configuration thereof can be changed in a variety of manners.

The communication interface 210 communicates with the sensing apparatuses 100. Specifically, the communication interface 210 is a wireless communication chip or a wireless communication module that communicates with the communication circuit 125 of each of the sensing apparatuses 100. For example, the communication interface 210 can be achieved by a wireless communication chip or a wireless communication module that performs communication in compliance with the LPWA standard and may instead be a wireless communication chip or a wireless communication module in compliance with a communication standard which differs from the LPWA standard but with which the communication circuit 125 complies. The communication interface 210 further communicates with the operation information database described later. In this case, the communication interface 210 may further include a wireless communication chip or a wireless communication module in compliance with a communication standard other than the communication standard used for communication with the sensing apparatuses 100. As described above, properly using a plurality of communication standards allows quick acquisition of the operation information from the operation information database while suppressing the power consumed by the sensing apparatuses 100.

The communication interface 210 receives information that associates the measurement result with the measurement time information representing the time when the measurement result is measured. Specifically, the communication interface 210 receives the measurement result and the measurement time information transmitted from the communication circuit 125 of each of the sensing apparatuses 100.

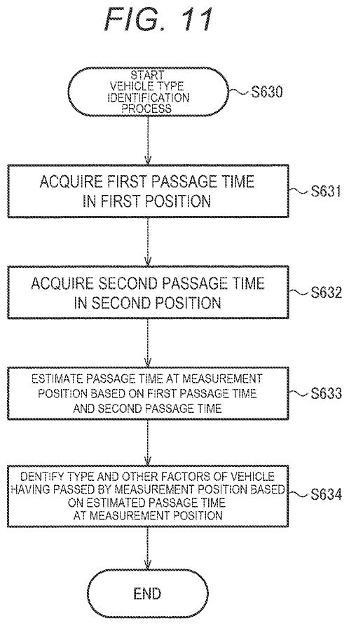

The processor 220 carries out processes relating to the control performed by the host system 200. The processor 220 can be achieved, for example, by the same hardware as that of the processing circuit 121, as described above. The processor 220 carries out the process of identifying the vehicle TR corresponding to the measurement result received via the communication interface 210. That is, the processor 220 identifies the vehicle TR corresponding to each of the plurality of measurement results based on the measurement time information, which represents the time when the measurement result is measured, and the operation information, which is the information on the operation status of the vehicle TR. Further, the processor 220 evaluates whether or not the measurement result received via the communication interface 210 is used in the abnormality evaluation process of evaluating abnormality of the structure ST based on the information on the identified vehicle TR. In other words, the processor 220 determines whether or not to use each of the plurality of measurement results in the structure abnormality evaluation process based on the vehicle identification result, which is the result of the identification of the vehicle TR. The aforementioned processes will be described later in detail in a measurement result analysis process (step S20) in FIG. 11.

The memory 230 stores a variety of pieces of information on the host system 200. The variety of pieces of information are, for example, the measurement results and the measurement time information received via the communication interface 210 and may also include the operation information acquired from the operation information database described later, estimated vehicle weight information, and other pieces of information. The processor 220 operates, for example, by using the memory 230 as a work area. The memory 230 may be an EEPROM (electrically erasable programmable read-only memory) or a flash memory, such as a MONOS (metal-oxide-nitride-oxide-silicon) memory. The memory 230 may instead be a semiconductor memory, such as an SRAM and a DRAM, a register, a magnetic storage apparatus, or an optical storage apparatus.

A case where a sensing apparatus 100 is used at the structure ST will next be described with reference to FIG. 5. The sensing apparatus 100 including the sensor 123 is disposed in a predetermined position on the structure ST that is a position located in the vicinity of a measurement position PT0. The measurement position PT0 is located between a first position PT1 and a second position PT2 on a road along which the vehicles TR travel. The first position PT1 and the second position PT2 are, for example, bus stops, and may instead be other positions where the operation status of each of the vehicles TR is recorded. It is assumed that the distance along the road between the first position PT1 and the measurement position PT0 is equal to the distance along the road between the measurement position PT0 and the second position PT2. When a vehicle TR passes by the measurement position PT0 during a period for which the sensor 123 can perform the measurement, the sensor 123 is configured to be capable of measuring the physical quantity of the structure ST. A plurality of sensors 123 may be disposed on the structure ST.

The vehicles TR are each, for example, a bus and may instead be a train, an automobile, or the like. The vehicles TR in the present embodiment include the first type vehicle TR1 and the second type vehicle TR2 and may further include vehicles of other types, such as the third type vehicle TR3. The first type vehicle TR1 is, for example, a small, lightweight bus. The second type vehicle TR2 is, for example, a large, heavy bus. The large bus and the small bus may be classified in compliance with the regulations specified by the Ministry of Land, Infrastructure, Transport and Tourism or may be classified by the user of the sensing system 10, that is, the user of the measurement system 1000 in accordance with the user's own criteria.

The structure ST is, for example, a tunnel, as shown in FIG. 5, but is not limited to a tunnel, and may instead be another artificial structure, such as a building, a bridge, a tower, a utility pole, and a dam. Further, the structure ST may include a natural structure, such as a mountain, a river, and a cliff.

In the present embodiment, the road on which the vehicles TR travel is, for example, a road for the exclusive use of buses, as a private road, and may instead be a public road on which general vehicles can travel.

The sensing apparatus 100 maybe used for maintenance of a machine installed, for example, in a factory. For example, the sensing apparatus 100 measures, for example, displacement that occurs when a machine having a movable portion operates. The machine used herein may, for example, be a manufacturing apparatus used to manufacture a product or a machine for packaging or any other purpose. The machine may instead be a robot having an arm and an end effector. The target of the maintenance is not limited to a machine and may be an environment in which the machine is installed, for example, a floor or a wall surface.

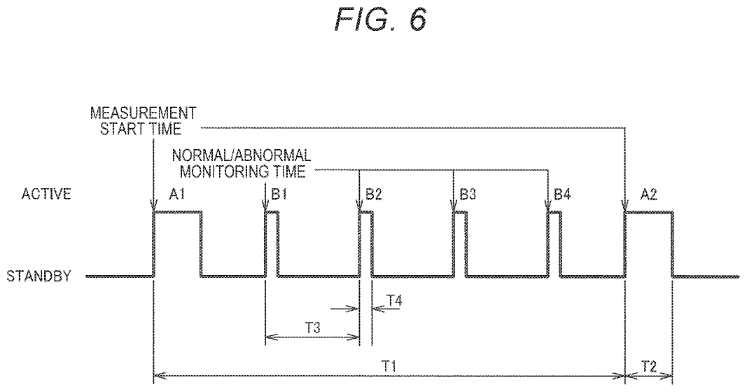

The operation of the sensing apparatus 100 will next be described. FIG. 6 describes basic intermittent operation of the sensing apparatus 100 in the present embodiment. The horizontal axis of FIG. 6 represents time. In FIG. 6, “ACTIVE” represents the state in which the power supply circuit 111 outputs Vdd, and “STANDBY” represents the state in which the power supply circuit 111 does not output Vdd. An ACTIVE period is a period for which the processing circuit 121 is operable but is not necessarily a period for which each portion of the second circuit 120 always operates. For example, since the sensor 123 and the communication circuit 125 are turned on and off by the processing circuit 121, the ACTIVE period has a period for which neither the sensor 123 nor the communication circuit 125 operates. In the ACTIVE period, the processing circuit 121 may operate in a low power consumption mode in which the power consumption is lower than that in a normal operation mode. The low power consumption mode used herein can be achieved, for example, by using an operation clock having a frequency lower than the frequency of the operation clock of the processing circuit 121 in the normal operation mode. Instead, in a mode in which the power consumption is relatively low, a variety of changes can be made to specific operation of the processing circuit 121.

A1 and A2 in FIG. 6 each represent a measurement period. The measurement period is a period for which the sensor 123 performs the measurement. The measurement period is not limited to A1 or A2. Processes carried out in the measurement period will be described later in detail.

The sensor 123 performs the measurement at the intervals labeled with T1, and one measurement period has a length T2. For example, T1 has a length of about one month, and T2 has a length of about one hour. For example, measurement start time information representing the measurement start time is set in advance in the clocking circuit 113. The measurement start time information used herein is information that can specify a year, a month, a day, an hour, a minute, and a second. For example, the measurement start time is the same time on the first day of every month. The clocking circuit 113 enables the power supply circuit 111 by turning on the alarm output when the current time reaches the measurement start time. After the processes to be carried out in the measurement period are completed, the processing circuit 121 instructs the clocking circuit 113 to turn off the alarm output. The power supply circuit 111 is thus disabled.

The sensing apparatus 100 can each thus acquire the sensor output information at the intervals labeled with T1 and transmit a measurement result based on the sensor output information to the host system 200. For example, the power consumption can be reduced by causing the sensing apparatus 100 to operate in the ACTIVE state only in A1, A2 and other measurement periods and causing the sensing apparatus 100 to operate in the STANDBY state in the other periods. Since Vdd is not supplied to the second circuit 120 in the STANDBY period, the current consumed, for example, by a pullup resistor in a peripheral circuit of the processing circuit 121 can also be reduced. Further, the resistance of the pullup resistor can be set at a large value that provides noise immunity.

When all periods other than the measurement periods are the STANDBY periods, however, the host system 200 can check the state of the sensing apparatus 100 only once a month. For example, even when the sensing apparatus 100 experiences abnormality, such as failure, the abnormality cannot be detected until the next measurement period. As a result, it is likely that the sensing is not performed properly in the next measurement period and part of the information is lost. Since the sensing apparatus 100 in the present embodiment is used in the health monitoring, for example, of the structure ST described above, loss of part of the information is not preferable.

To avoid the loss, operating status monitoring may be performed on the sensing apparatus 100. B1, B2, B3, and B4 in FIG. 6 each represent an operating status monitoring period. The operating status monitoring period is a period for checking whether or not the sensing apparatus 100 is operating normally. Time synchronization may be performed in the operating status monitoring period and will be described later in detail in a variation.

The operating status monitoring is performed at the intervals labeled with T3 in FIG. 6, and one operating status monitoring period has a length T4. T3 is shorter than T1. T4 is shorter than T2. For example, T3 has a length of about one week, and T4 has a length of about several minutes. For example, operating status monitoring time information representing the time when the operating status monitoring starts is set in advance in the clocking circuit 113. The time when the operating status monitoring starts is hereinafter referred to as operating status monitoring time. The operating status monitoring time information used herein is information that can specify a year, a month, a day, an hour, a minute, and a second. For example, the operating status monitoring time is the same time every Wednesday. The operating status monitoring is therefore not necessarily performed in the operating status monitoring periods B1 to B4 shown in FIG. 6 but is in some cases performed in the operating status monitoring periods B1 to B5, and it is assumed in the description that the operating status monitoring period B4 is immediately before the measurement periods A1 and A2 and other measurement periods. The clocking circuit 113 enables the power supply circuit 111 by turning on the alarm output when the current time reaches the operating status monitoring time. After the operating status monitoring is completed, the processing circuit 121 instructs the clocking circuit 113 to turn off the alarm output. The power supply circuit 111 is thus disabled.

Performing the operating status monitoring as described above allows appropriate monitoring of the state of the sensing apparatus 100. Since abnormality of the sensing apparatus 100 is detected at an early stage, the abnormal sensing apparatus 100 can be repaired or otherwise handled by the next measurement period. Since the sensor 123 does not need to perform the measurement for a long period in the operating status monitoring period, the operating status monitoring period can be shorter than the measurement period. The ACTIVE period is therefore not excessively long even when the operating status monitoring is performed, whereby the power consumed by the sensing apparatus 100 can be reduced.

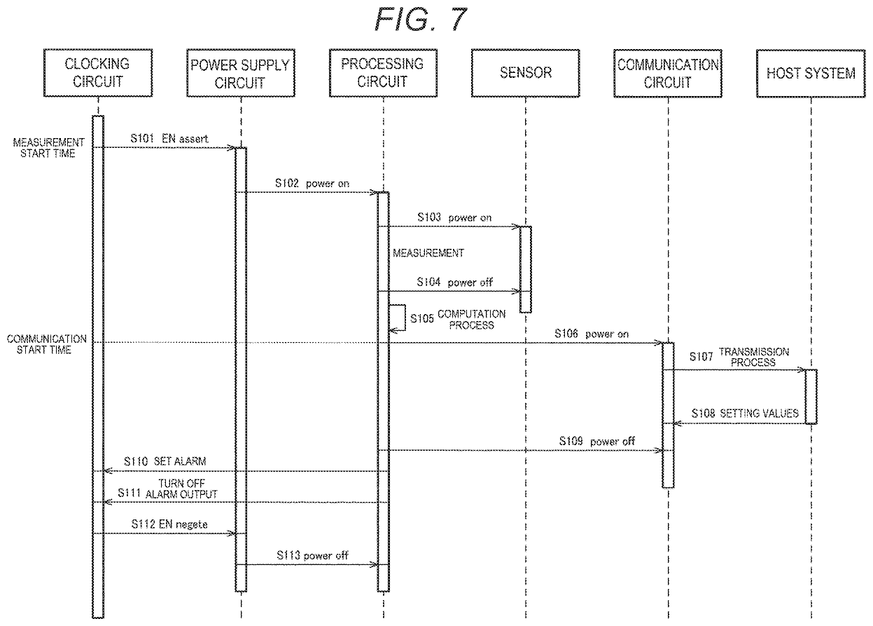

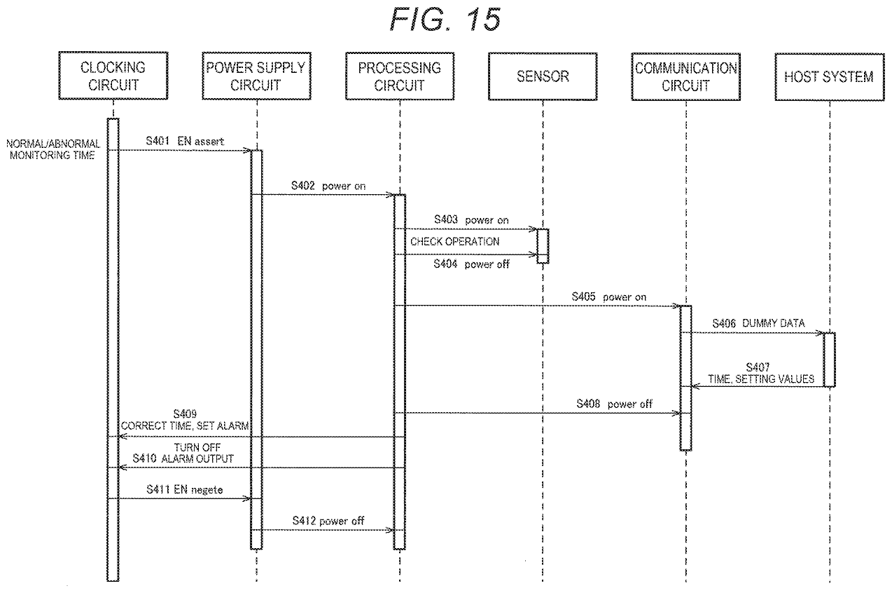

Processes carried out by the sensing apparatus 100 including the measurement performed by the sensor 123 will next be described with reference to FIG. 7. First, the clocking circuit 113 compares the time information held thereby with the measurement start time indicated by the measurement start time information. The clocking circuit 113 turns on the alarm output when the current time reaches the measurement start time. Specifically, in step S101, the clocking circuit 113 asserts the enable signal for the power supply circuit 111. It is noted that FIG. 7 diagrammatically shows the procedure of the processes, and that the length in the vertical axis direction does not represent a specific length of time. The same holds true for FIGS. 8 and 15 described later.

When the enable signal is asserted, the power supply circuit 111 outputs Vdd based on Vbat. Specifically, in step S102, the power supply circuit 111 turns on the processing circuit 121 by supplying the processing circuit 121 with Vdd. In other words, the power supply circuit 111 is activated by a second activation instruction from the clocking circuit 113 and supplies the processing circuit 121 with the power supply voltage Vdd.

In step S103, the processing circuit 121 turns on the sensor 123 to cause the sensor 123 to start the measurement. Specifically, the processing circuit 121 turns on the switch element SW1 to start supplying the sensor 123 with Vdd. The sensor 123 operates based on Vdd to output the sensor output information to the processing circuit 121.

The measurement performed by the sensor 123 continues for, for example, one hour. Therefore, when one hour has elapsed from the start of the measurement, the processing circuit 121 turns off the sensor 123 to terminate the measurement in step S104. Specifically, the processing circuit 121 turns off the switch element SW1 to stop supplying the sensor 123 with Vdd.

Thereafter, in step S105, the processing circuit 121 carries out the computation process based on the sensor output information from the sensor 123 to generate a measurement result. In other words, the physical quantity measurement method according to the present embodiment carries out the process of computing as the measurement result a physical quantity representing displacement of the structure ST that occurs when the vehicle TR passes therethrough based on the measurement data outputted from the sensor 123. The measurement result is, for example, information that serves as an index representing whether or not abnormality has occurred in a target object under the sensing. For example, the processing circuit 121 sequentially acquires time-series data on the physical quantity, such as acceleration, as the sensor output information from the sensor 123, for example, when the vehicle TR passes through the structure ST. The processing circuit 121 performs frequency conversion, such as Fourier transform, on the time-series data. For example, the processing circuit 121 carries out the process of determining a peak frequency and the spectral intensity at the peak frequency as the measurement result based on the result of the Fourier transform. The processing circuit 121 may evaluate whether or not abnormality has occurred by comparing a normal-time peak frequency and spectral intensity acquired in advance with the peak frequency and the spectral intensity determined by the computation. The measurement result in this case is information representing whether or not abnormality has occurred.

Further, the processing circuit 121 generates measurement data whenever the vehicle TR passes once. Therefore, for example, the processing circuit 121 carries out the process of extracting information corresponding to a movement period over which the vehicle TR moves from the sensor output information acquired by the one-hour measurement. For example, since the acceleration has a large amplitude when the vehicle TR is moving and a small amplitude when the vehicle TR is not moving, the information extraction process can be achieved by an approach for evaluating whether or not the vehicle TR has passed based on the amplitude of the acceleration. When a plurality of vehicles TR move in one hour, a plurality of movement periods are set. The above process, such as Fourier transform and integration, is performed on a movement period basis.

The processing circuit 121 may carryout the process of determining the velocity or displacement of the target object by integrating the acceleration data. The measurement result is, for example, the displacement of a given portion of the target object. The processing circuit 121 may evaluate whether or not abnormality has occurred by comparing the determined displacement with a given threshold.

Instead, the processing circuit 121 may determine, as the measurement result, ratio information representing the ratio between the maximum amplitude of the acceleration in a predetermined axis direction and the maximum amplitude of the acceleration in a direction perpendicular to the predetermined axis. The ratio information is known to correlate with the natural frequency of the target object and is therefore information suitable for monitoring of the target object. There is also a known approach using a power spectrum of regular slight movement caused by a natural phenomenon, such as wind, as the index that correlates with the natural frequency, and the processing circuit 121 in the present embodiment may compute information based on the power spectrum as the measurement result.

Referring back to FIG. 7, the description resumes. The computation process in step S105 generates the measurement result to be transmitted. In the present embodiment, the communication does not always start at the time when the computation of the measurement result is completed, and the communication start at arbitrary time. Therefore, although not shown, the processing circuit 121 waits after the completion of the computation process in step S105 but before the communication start time indicated by the communication start time information. The processing circuit 121 may acquire the current time used to evaluate whether or not the communication start time has been reached from the clocking circuit 113. The processing circuit 121 may instead acquire the time information from the clocking circuit 113 at the time of the activation of the processing circuit 121 and measure the current time afterward, for example, by using the operating clock signal of the processing circuit 121 itself. The communication start time may also be set in the clocking circuit 113, and the alarm output may be outputted from the clocking circuit 113 to the processing circuit 121 when the current time reaches the communication start time. Although not shown or otherwise illustrated, the processing circuit 121 may operates in the low power consumption mode from the end of the computation process in step S105 to the communication start time. Instead, the processing circuit 121 may operate in the low power consumption mode for a fixed period after step S104 and then carry out the computation process in step S105 after returning to the normal operation mode. The power consumed by the sensing apparatus 100 can thus be reduced.

Thereafter, when the current time reaches the communication start time, the processing circuit 121 turns on the communication circuit 125 to cause the communication circuit 125 to start transmitting the measurement result in step S106. Specifically, the processing circuit 121 turns on the switch element SW2 to start supplying the communication circuit 125 with Vdd.

In step S107, the communication circuit 125 operates based on Vdd to perform the transmission. Specifically, the measurement result and the measurement time information are transmitted to the host system 200. As described above with reference to FIG. 2, the communication with the host system 200 may, for example, be the communication via the gateway terminal GW.

In step S108, the communication circuit 125 receives setting values from the host system 200. The setting value received in step S108 includes, for example, the next operating status monitoring time information, the next measurement start time information, and the reference time information and may further include other pieces of information.

After the setting value receipt period ends, the processing circuit 121 turns off the communication circuit 125 to terminate the communication in step S109. Specifically, the processing circuit 121 turns off the switch element SW2 to stop supplying the communication circuit 125 with Vdd.

In step S110, the processing circuit 121 sets the clocking circuit 113 based on the information received by the communication circuit 125 in step S108. Specifically, the processing circuit 121 corrects the time information from the clocking circuit 113 based on the reference time information. Further, the processing circuit 121 carries out the process of setting the measurement start time information and the operating status monitoring time information in the clocking circuit 113. The clocking circuit 113 can thus turn on the alarm output at the next measurement start time and the next operating status monitoring time.

In step S111, the processing circuit 121 turns off the alarm output from the clocking circuit 113. The clocking circuit 113 thus negates the enable signal for the power supply circuit 111 in step S112. When the enable signal is negated, the power supply circuit 111 stops outputting Vdd based on Vbat. Specifically, the power supply circuit 111 turns off the processing circuit 121 by stopping supplying Vdd in step S113.

As described above, in the approach according to the present embodiment, after the power supply circuit 111 is activated by the alarm output from the clocking circuit 113, Vdd supplied from the power supply circuit 111 causes the processing circuit 121 to start operating. The timing at which the alarm output from the clocking circuit 113 is turned on is determined, for example, by the measurement start time set by the processing circuit 121. Therefore, in the state in which the processing circuit 121 has not performed the settings, the clocking circuit 113 does not output the alarm, so that the power supply circuit 111 is not activated. Further, since the processing circuit 121 does not operate in the state in which the power supply circuit 111 is not activated, the processing circuit 121 cannot set the clocking circuit 113. As a result, the sensing apparatus 100 cannot start operating.

Therefore, in the present embodiment, an initialization process may be carried out separately from the processes shown in FIGS. 6 and 7. The initialization process is, for example, a process carried out before the sensing apparatus 100 is installed at a target object.

FIG. 8 describes the procedure of the initialization process. When the initialization process starts, the battery BAT is first coupled to the sensing apparatus 100. As a result, Vbat, which is the battery voltage, is supplied to the first circuit 110 including the clocking circuit 113 in step S501. Thereafter, instep S502, the user manually asserts the enable signal for the power supply circuit 111. The process in step S502 is carried out, for example, by using a jumper pin. When the enable signal is asserted, the power supply circuit 111 outputs Vdd based on Vbat. Specifically, in step S503, the power supply circuit 111 turns on the processing circuit 121 by supplying the processing circuit 121 with Vdd.

In step S504, the processing circuit 121 sets the clocking circuit 113. Specifically, the processing circuit 121 corrects the time information from the clocking circuit 113 based on the reference time information. Further, the processing circuit 121 carries out the process of setting the measurement start time information and the operating status monitoring time information in the clocking circuit 113. The clocking circuit 113 can thus turn on the alarm output at the measurement start time or the operating status monitoring time. The process in step S504 is carried out, for example, by using the external information processing apparatus coupled via the interface 127 in FIG. 3. For example, the user causes the processing circuit 121 to set the clocking circuit 113 by causing the information processing apparatus, such as a PC (personal computer), to transmit a command. The command includes a command for setting the communication start time information in the sensing apparatus 100. For example, instep S504, the storage 129 stores the communication start time information inputted via the interface 127.

In step S505, the processing circuit 121 transmits to the information processing apparatus a notification stating that the setting of the clocking circuit 113 has been completed. The process in step S505 is carried out via the interface 127, as in step S504. For example, the processing circuit 121 transmits a notification stating that step S505 has ended as a response to the command inputted from the information processing apparatus. After step S505, the processing circuit 121 carries out a STANDBY preparation process in step S506. Having received the end notification, the user manually negates the enable signal for the power supply circuit 111 in step S507. The process in step S507 is carried out, for example, by using a jumper pin, as in step S502. When the enable signal is negated, the power supply circuit 111 stops outputting Vdd based on Vbat. Specifically, in step S508, the power supply circuit 111 turns off the processing circuit 121 by stopping supplying the processing circuit 121 with Vdd.

The measurement start time and other pieces of information are set in the clocking circuit 113 by carrying out the initialization process shown in FIG. 8. The processes shown in FIGS. 6 and 7 can thus be appropriately carried out . Further, at the end of the processes in FIG. 7, neither the power supply circuit 111 nor the processing circuit 121 is in operation, whereby the power consumption can be reduced.

### 3. Abnormality Evaluation Process

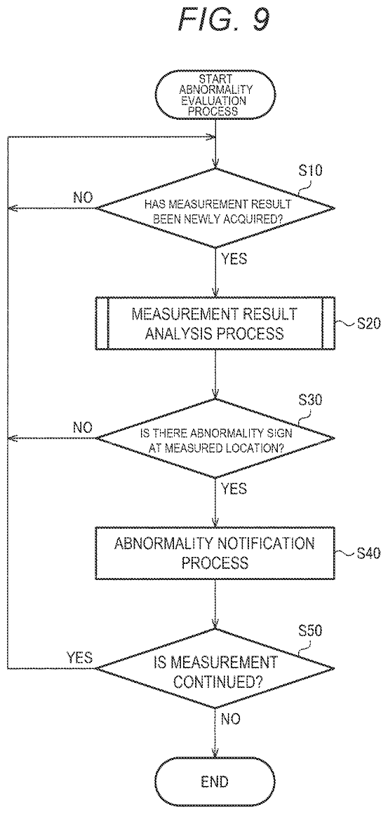

An example of how to carry out the abnormality evaluation process in the present embodiment will next be described with reference to the flowchart of FIG. 9. The main portion that carries out the abnormality evaluation process is not limited to a specific portion, and the following description will be made on the assumption that the processor 220 carries out the abnormality evaluation process. The content of the abnormality evaluation process is not limited to the example shown in FIG. 9 and can be changed in a variety of manners.

First, when the processor 220 newly acquires a measurement result from the sensing apparatus 100 (YES instep S10), the processor 220 carries out a measurement result analysis process (step S20) described later. When the result of the measurement result analysis process (step S20) shows that there is an abnormality sign at the measurement location (YES in step S30), the processor 220 carries out an abnormality notification process (step S40), and when the processor 220 determines that there is no abnormality sign at the measurement location (NO in step S30), the processor 220 waits acquisition of a new measurement result. The abnormality notification process in step S40 is, for example, the process of causing the host system 200 to notify an manager of the structure ST of abnormality, for example, in the form of sound or a message, but not limited thereto.

Having carried out the abnormality notification process (step S40), the processor 220 evaluates whether or not to continue the measurement, and when the processor 220 determines to continue the measurement (YES in step S50), the processor 220 waits for acquisition of a new measurement result. The case where the processor 220 determines to continue the measurement is, for example, a case where the processor 220 determines that the structure ST can be used for a while although there is an abnormality sign. On the other hand, when the processor 220 determines not to continue the measurement (NO in step S50), the processor 220 terminates the procedure. The case where the processor 220 determines not to continue the measurement is, for example, a case where the use of the structure ST is terminated or a case where the measurement is temporarily suspended due to maintenance of the structure ST or any other situation. In other words, the procedure of the abnormality evaluation process is continuously carried out until a situation that causes the measurement to be suspended occurs. Although not shown or illustrated, it is conceivable to add the process of evaluating whether or not to continue the measurement based on an evaluation criterion set, for example, by the manager of the structure ST.

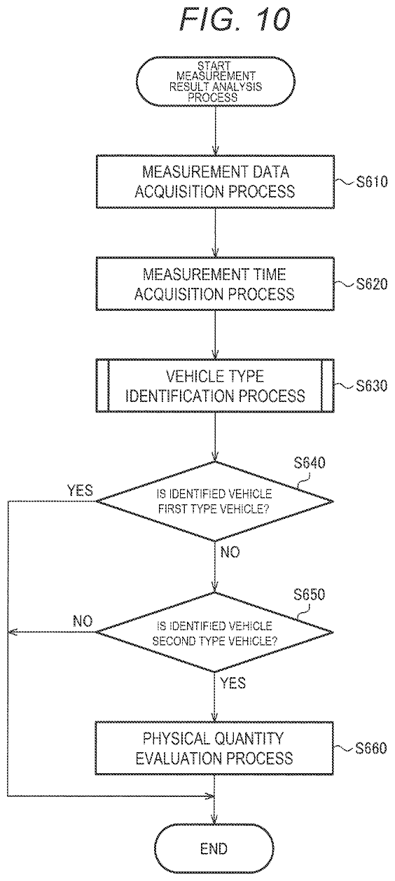

The measurement result analysis process (step S20) will next be described with reference to FIG. 10. The processor 220 first carries out a measurement data acquisition process (step S610) and then carries out a measurement time acquisition process (step S620). Specifically, the communication interface 210 carries out the process of acquiring measurement results and the measurement time information via the communication circuit 125.

The processor 220 then carries out a vehicle type identification process (step S630) to identify the vehicle type relating to the target measurement result. The vehicle type identification process (step S630) will be described later in detail. When the identified vehicle TR is the first type vehicle TR1 described above (YES in step S640), the processor 220 terminates the procedure without carrying out a physical quantity evaluation process (step S660) described later. That is, when the measurement result is provided by the first type vehicle TR1 passing by the measurement position PT0, the processor 220 carries out the process of causing the measurement result not to undergo the abnormality evaluation process. In other words, in the physical quantity measurement method according to the present embodiment, when the vehicle TR corresponding to a measurement result is identified as the first type vehicle TR1, the processor 220 does not carry out the abnormality determination process based on the measurement result. The reason why a measurement result provided by the first type vehicle TR1 is not caused to undergo the abnormality evaluation process is that a lightweight vehicle may cause a decrease in measurement sensitivity and an increase in influence of variation in the number of passengers.

A measurement result unsuitable for the abnormality evaluation process can thus be excluded, whereby the accuracy of the evaluation of the soundness of the structure ST can be improved.

Thereafter, when the evaluated vehicle TR is the second type vehicle TR2 described above (YES in step S650), the processor 220 carries out the physical quantity evaluation process (step S660) . The physical quantity evaluation process (step S660) is, for example, the process of evaluating whether or not the physical quantity in the currently newly acquired measurement result affects the state of the structure ST based on the physical quantity relating to the measurement results having been accumulated. That is, in the physical quantity measurement method according to the present embodiment, when the vehicle TR corresponding to a measurement result is identified as the second type vehicle TR2, the abnormality evaluation process is carried out based on the measurement result. Since the second type vehicle TR2 has a heavy vehicle weight as described above, the problem with a measurement result provided by the passage of the first type vehicle TR1 does not occur. Only measurement results suitable for the abnormality evaluation process can thus be accumulated, whereby the accuracy of the evaluation of the soundness of the structure ST can be improved. After the physical quantity evaluation process (step S660) is completed, the processor 220 returns to the procedure of the abnormality evaluation process again. In other words, the physical quantity measurement method according to the present embodiment carries out the abnormality evaluation process based on the physical quantity.

When the identified vehicle is a vehicle other than the second type vehicle TR2 described above (NO in step S650), the processor 220 terminates the procedure without carrying out the physical quantity evaluation process described above (step S660). A vehicle TR other than the second type vehicle TR2 is, for example, the third type vehicle TR3 described above or may be a vehicle of another type. The third type vehicle TR3 used herein is, for example, a vehicle TR that carries passengers the number of which greatly varies and may instead be a vehicle TR having other factors.

When steps S640 and S650 identify a vehicle TR corresponding to a predetermined type vehicle that is, for example, the first type vehicle TR1 or the third type vehicle TR3, the measurement result provided by the vehicle TR does not undergo the abnormality evaluation process. In other words, in the physical quantity measurement method according to the present embodiment, when a vehicle TR corresponding to a measurement result is identified as the predetermined type vehicle, the abnormality evaluation process is not carried out based on the measurement result.

A measurement result unsuitable for the abnormality evaluation process can thus be excluded, whereby the accuracy of the evaluation of the soundness of the structure ST can be improved.

The vehicle type identification process (step S630) will next be described with reference to FIG. 11. The processor 220 carries out the process (step S631) of acquiring first passage time that is the time when the vehicle TR passes by the first position PT1 in FIG. 5 and then carries out the process (step S632) of acquiring second passage time that is the time when the vehicle TR passes through the second position PT2 in FIG. 5. Specifically, an organization that manages the operation of the vehicle TR possesses an operation information database containing operation information on the actual passage of the vehicle TR by the first position PT1 and the second position PT2, and the communication interface 210 of the host system 200 carries out the process of acquiring the operation information from the operation information database via a predetermined network. In the example of the processes in FIG. 11, the processes in steps S631 and S632 are carried out when the measurement result is acquired and may instead be carried out regularly independently of the abnormality evaluation process.

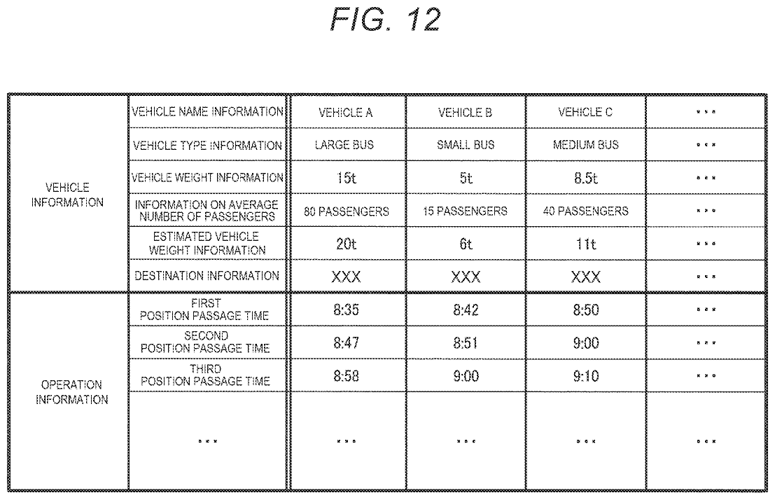

In the operation information database, which contains the operation information, the operation information may be associated with the vehicle information on each of the operating vehicles TR, as shown in FIG. 12. The vehicle information includes, for example, vehicle name information, vehicle type information, vehicle weight information, information on the average number of passengers, estimated vehicle weight information, and destination information. The vehicle weight information refers to information representing the weight in a state in which the vehicle TR is operable and also containing the weight of the fuel, such as gasoline. The estimated vehicle weight information is an estimated total vehicle weight that is the sum of the vehicle weight, the passengers, and luggage that belongs to the passengers. The estimated vehicle weight information may be automatically calculated from the vehicle weight information, the information on the average number of passengers, and other pieces of information.

The vehicle information may further include, for example, information on the standard deviation or variance of the number of passengers of the vehicle TR. The degree of variation in the number of passengers can thus be grasped, whereby the grasped degree can be used as a criterion for evaluating whether or not the measurement result is applied to the abnormality evaluation process.

Returning to FIG. 11, the description resumes. The processor 220 carries out the process of estimating the time when the vehicle TR passed by the measurement position PT0 (step S633) based on the first passage time when the vehicle TR passed by the first position PT1 and the second passage time when the vehicle TR passed by the second position PT2. In other words, the physical quantity measurement method according to the present embodiment estimates passage time information representing the time when the vehicle TR passes through the structure ST based on the operation information. Specifically, the processor 220 calculates, for example, the distance between the first position PT1 and the measurement position PT0 and the distance between the measurement position PT0 and the second position PT2, for example, from map information to compute estimated time. For example, since the middle time between the first passage time and the second passage time is the estimated time when the vehicle TR passed by the measurement position PT0, it is estimated that the vehicle A in FIG. 12 passed by the measurement position PT0 at 8:42. The passage time information may be estimated further in consideration, for example, of traffic congestion information. Although not shown, the processor 220 may carry out the process of associating the estimated time with the operation information.

The processor 220 then carries out the process of identifying the type and other factors of the vehicle having passed by the measurement position PT0 based on the estimated passage time at the measurement position PT0 (step S634). In other words, the physical quantity measurement method according to the present embodiment identifies the vehicle TR corresponding to the measurement result based on the measurement time information and the passage time information. Specifically, for example, the identification can be achieved by carrying out the process of searching for vehicle information associated with the estimated time that coincides with the time in the measurement time information, and the identification may be achieved by another method. It is conceivable to add the process of notifying an error when the measurement time information and the estimated time information deviate from each other by at least a certain period.

Since the vehicle TR corresponding to the measurement result can thus be identified, whether or not the measurement result is caused to undergo the abnormality evaluation process can be evaluated, whereby the accuracy of the evaluation of the soundness of the structure ST can be improved.

### 4. Other Variations

The physical quantity measurement method and the measurement system according to the present embodiment can be changed in a variety of variations, for example, by adding other configurations, as described above. For example, in place of the process of identifying the vehicle TR, for example, the process in step S630 described above, the process of identifying the estimated vehicle weight information on the vehicle TR involved in the measurement result may be carried out, and the abnormality evaluation process maybe carried out based on the estimated vehicle weight information and the measurement result. For example, although not shown, step S634 in FIG. 11 may be achieved, for example, by carrying out the process of identifying the estimated vehicle weight information instead of identifying the vehicle type. The estimated vehicle weight information can be identified by associating it with the operation information, as shown in FIG. 12.

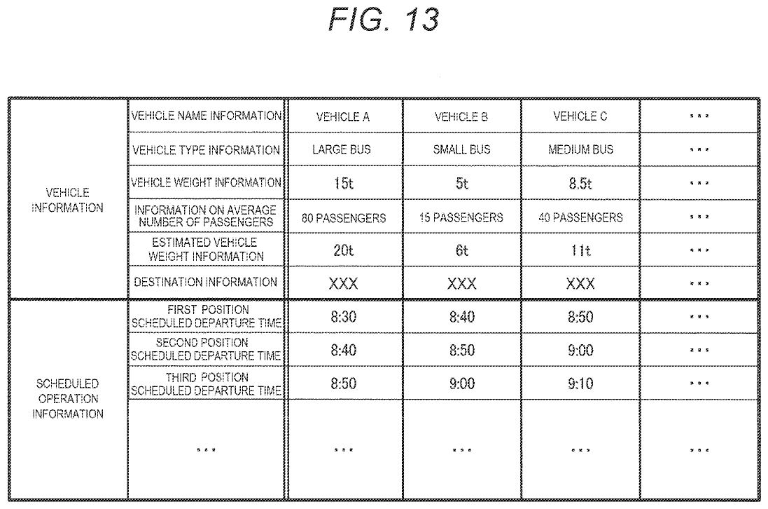

When a predetermined condition is satisfied, the sensing apparatus 100 may pair the estimated vehicle weight information with the measurement result provided by the computation process (step S105) and transmit the result of the paring to the host system 200. For example, it is difficult for the storage 129 of the sensing apparatus 100 to carry out the process of acquiring the operation information in consideration, for example, of the communication burden and the capacity of the battery, but information that associates the vehicle information with the scheduled operation time information can be stored in advance, as shown in FIG. 13. In other words, the physical quantity measurement method according to the present embodiment stores the estimated vehicle weight information, which is the information that associates the vehicle TR with the estimated weight of the vehicle TR. Therefore, although not shown, the processing circuit 121 computes scheduled vehicle passage time information on scheduled vehicle passage time at the measurement position by carrying out the same processes as those in steps S631 to S633 in FIG. 11 based on scheduled operation information and compares the scheduled vehicle passage time with the measurement time information to identify the estimated vehicle weight information corresponding to the measurement result. In other words, the physical quantity measurement method according to the present embodiment identifies the estimated vehicle weight information corresponding to the measurement result based on the result of the identification of the vehicle and carries out the abnormality evaluation process based on the identified estimated vehicle weight information and the measurement result. The predetermined condition is, for example, that the road on which the vehicle TR travels corresponds to the aforementioned road for the exclusive use of buses, which is a private road. The reason for this is that the road for the exclusive use of buses, which is a private road, has few factors that disturb the operation status of the buses and it is therefore highly possible that the scheduled vehicle passage time information coincides with the passage time information.

Whether or not a measurement result is suitable for the abnormality evaluation process can thus be evaluated based on the estimated vehicle weight, which directly affects the measurement sensitivity.

The measurement start time information representing the measurement start time is set in advance in the clocking circuit 113, as described above, and the clocking performed by the clocking circuit 113 produces a certain time error due to variation in the characteristics of the oscillator, the temperature, aging deterioration, the circuit layout, and other factors. An increase in the time error causes a problem of an increase in the aforementioned deviation between the measurement time information and the estimated time. To avoid the problem, in the physical quantity measurement method according to the present embodiment, time information for correction may be acquired before the sensor starts the measurement, and the measurement result may be acquired based on the time corrected by the time information for correction. In other words, the physical quantity measurement method may acquire the time information for correction before the sensor 123 starts the measurement and acquire a measurement result based on the time corrected by the time information for correction.

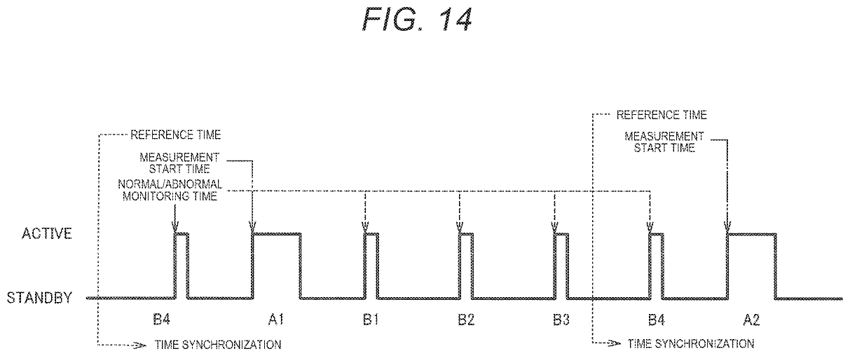

FIG. 14 describes an example of the relationship between the intermittent operation of the sensing apparatus 100 and the timing of the time synchronization. In the example shown in FIG. 14, the time synchronization is performed in the operating status monitoring period B4 immediately before the measurement period. Reference characters A1, A2, and B1 to B3 in FIG. 14 are the same as those in FIG. 6 and will therefore not be descried.

FIG. 15 describes an example of the procedure of processes in the operating status monitoring period B4 in FIG. 14. It is assumed that the initialization process described in FIG. 8 has been completed and the measurement start time has been set in the clocking circuit 113 before the processes in the operating status monitoring period B4 are carried out. It is further assumed that the sensing apparatus 100 has acquired the operating status monitoring time information and the communication start time information. Further, before the start of the processes shown in FIG. 15, it is assumed that the sensing apparatus 100 operates in the STANDBY state in FIG. 14, and that Vbat from the battery BAT is supplied but only the clocking circuit 113 is in operation.

The clocking circuit 113 carries out the process of comparing the time held thereby with the operating status monitoring time indicated by the operating status monitoring time information. The clocking circuit 113 turns on the alarm output when the current time reaches the operating status monitoring time. Specifically, in step S401, the clocking circuit 113 asserts the enable signal for the power supply circuit 111. In step S402, the power supply circuit 111 turns on the processing circuit 121 by supplying the processing circuit 121 with Vdd. In other words, the power supply circuit 111 is activated by a first activation instruction from the clocking circuit 113 and supplies the processing circuit 121 with the power supply voltage Vdd in a first period.

In step S403, the processing circuit 121 turns on the sensor 123 to cause the sensor 123 to start the measurement. In the operating status monitoring period, the processing circuit 121 only needs to ascertain that the sensor 123 is outputting information, and the sensor 123 has a low necessity of continuing the measurement for a long period. Therefore, for example, the processing circuit 121 turns off the sensor 123 to terminate the measurement in step S404 at the timing at which the processing circuit 121 ascertains that the sensor output information is outputted. The processing circuit 121 may generate a measurement result having an amount large enough to allow the computation process described later to be carried out in step S105 in FIG. 7 described above.

In the operating status monitoring period, the processes in steps S403 and S404 may be omitted. In this case, abnormality of the sensor 123 cannot be detected, but the operation of the power supply circuit 111, the clocking circuit 113, the processing circuit 121, the communication circuit 125, and other circuits can be checked.

After the process in step S404, the processing circuit 121 does not wait or transition to the low power consumption mode but turns on the communication circuit 125 to cause the communication circuit 125 to start transmitting the operating status monitoring information in step S405. For example, in step S406, the communication circuit 125 transmits dummy data having an arbitrary content to the host system 200. The operating status monitoring information may be a specific data string representing the operating status monitoring.

In step S407, the communication circuit 125 receives information from the host system 200. The received information is, for example, the reference time information and setting values. The setting values include the measurement start time information and the communication start time information and may include other pieces of information. The reference time information is information for correcting the time information outputted by the clocking circuit 113, in other words, the time information for correction. For example, the host system 200 can acquire standard time via the network NW, such as the Internet. The host system 200 transmits information based on the standard time as the reference time information to the sensing apparatus 100. That is, the communication circuit 125 receives the time information for correction in the first period. Thereafter, instep S408, the processing circuit 121 turns off the communication circuit 125 to terminate the communication.

The communication start time information may vary among the sensing apparatuses 100. Collision in the communication can thus be avoided. The collision occurs when the plurality of sensing apparatuses 100 communicate with the host system 200 as shown in FIG. 2 and two or more sensing apparatuses 100 simultaneously transmit measurement results. In particular, in the communication between the sensing apparatuses 100 and the gateway terminal GW, a protocol that does not perform sufficient retransmission control maybe used. Therefore, when the plurality of sensing apparatuses 100 simultaneously transmit information to the gateway terminal GW, the information may be lost due to the collision. Further, the collision not only occurs in the communication between the sensing apparatuses 100 and a relay apparatus, such as the gateway terminal GW, but may occur in some cases when the host system 200 receives data.

Returning to FIG. 15, the description resumes. In step S409, the processing circuit 121 sets the clocking circuit 113 based on the information received by the communication circuit 125 in step S407. That is, the clocking circuit 113 corrects the time information based on the time information for correction.

In step S410, the processing circuit 121 turns off the alarm output from the clocking circuit 113. The clocking circuit 113 thus negates the enable signal for the power supply circuit 111 in step S411. When the enable signal is negated, the power supply circuit 111 stops outputting Vdd based on Vbat. Specifically, in step S412, the power supply circuit 111 turns off the processing circuit 121 by stopping supplying the processing circuit 121 with Vdd. That is, the power supply circuit 111 stops operating upon receipt of a first stop instruction from the clocking circuit 113.

The error produced in the clocking performed by the clocking circuit 113 can thus be reduced before the sensor 123 starts the measurement, whereby the aforementioned deviation between the measurement time information and the estimated time can be reduced.

The time synchronization may instead be performed by providing a period different from the operating status monitoring period described above. For example, although not shown, the time synchronization can be achieved by separately providing a correction instruction period C between the operating status monitoring period B4 and each of the measurement periods A1, A2 and other measurement periods and carrying out the same processes as those in FIG. 15 in the correction instruction period C.

FIGS. 14 and 15 in the present embodiment describes that the time synchronization is performed in the operating status monitoring period B4, and the time synchronization may be performed similarly in the operating status monitoring periods B1 to B3. Since the operating status monitoring periods B1 to B3 are not each an operating status monitoring period immediately before the measurement starts, part of the processes to be carried out therein may be omitted. Part of the processes include, for example, the process of receiving the reference time information from the host system 200, as in step S407 in FIG. 15, and the process in which the processing circuit 121 sets the clocking circuit 113 based on the information received by the communication circuit 125 in step S407, as in step S409 in FIG. 15.

The host system 200 may be configured to be capable of adjusting the day to which the operating status monitoring period belongs to the day before the day to which the measurement period belongs. Specifically, the host system 200 can achieve the adjustment by adjusting the day to which the operating status monitoring period B4 belongs to the day before the day to which the measurement period belongs. For example, in the above description with reference to FIGS. 6 and 14, the day to which the measurement period belongs is the first day of each month, and the day to which the operating status monitoring period belongs is every Wednesday. In this case, however, the day before the day to which the measurement period belongs is not always Wednesday. Therefore, for example, when the host system 200 transmits the setting values to the communication circuit 125 in step S108 in FIG. 7, the host system 200 may determine the day of the week to which the next measurement start time information belongs and compute the setting values in such a way that the day of the week before the determined day of the week is the day of the week in the operating status monitoring period. For example, when the day to which the next measurement start time belongs is Tuesday, the host system 200 can achieve the adjustment described above by reflecting the following condition in the setting values that the day to which the operating status monitoring period belongs is every Monday.

Since the day to which the operating status monitoring period B4, in which the time synchronization is performed, belongs is adjacent to the day to which the measurement period belongs, the error that occurs in the clocking circuit 113 after the time synchronization is reduced, whereby the measurement time information can be more accurate.

An example in which the process of identifying a vehicle TR is carried out in the host system 200 has been described above, and the process of identifying a vehicle TR maybe carried out on the sensing apparatus 100. In other words, it is conceivable to employ a configuration in which both the measurement section 1100 and the determination section 1200 of the measurement system 1000 correspond to the sensing apparatus 100. For example, the variation described above can be achieved by adding the function that allows the communication circuit 125 to receive the operation information described above to the configuration of the sensing apparatus 100 shown in FIG. 3. The operation information may be received from the operation information database described above or may be received via the host system 200. In other words, the sensing apparatuses 100 each include the sensor 123 for physical quantity computation, which is attached to a structure through which the plurality of vehicles TR pass, the processing circuit 121, and the communication circuit 125, which receives the operation information representing the operation status of the vehicles TR. The processing circuit 121 acquires a plurality of measurement results corresponding to the passage of the plurality of vehicles TR based on the measurement performed by the sensor 123.

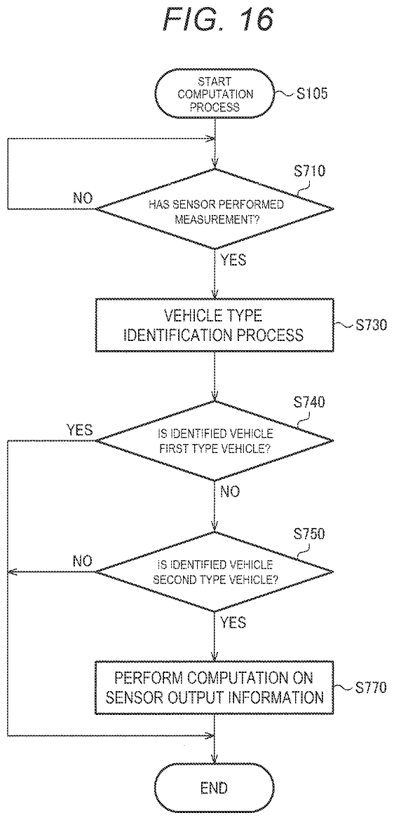

FIG. 16 is a flowchart showing an example of a variation of the computation process described above (step S105) . When the processing circuit 121 determines that the sensor has performed the measurement (YES in step S710) , the processing circuit 121 carries out the vehicle type identification process (step S730) , as in step S630 described above. In other words, based on the measurement time information on the time when a vehicle TR passes by the measurement position PT0, the passage time information is estimated for the measurement result provided by the passage of the vehicle TR, and the vehicle TR is identified based on the estimated passage time information.

When the processing circuit 121 determines that the identified vehicle TR is not the first type vehicle TR1 (NO in step S740) but is the second type vehicle TR2 (YES in step S750), as in steps S640 and S650 described above, the processing circuit 121 carries out the process of performing computation on the sensor output information (step S770). On the other hand, when the processing circuit 121 determines that the identified vehicle is the first type vehicle TR1 (YES in step S740) or that the identified vehicle is a vehicle TR other than the second type vehicle TR2 (NO in step S750), the processing circuit 121 terminates the procedure without performing computation on the sensor output information. Thereafter, the process in step S107 described above causes only the measurement result provided by the second type vehicle TR2 to be transmitted to the host system 200, and the host system 200 carries out the abnormality evaluation process. In other words, the processing circuit 121 identifies the vehicle TR corresponding to each of the plurality of measurement results based on the measurement time information representing the time when the measurement result is measured and the operation information, which is the information on the operation status of the vehicle TR. Further, the processing circuit 121 determines whether or not to use each of the plurality of measurement results in the abnormality evaluation process of evaluating abnormality of the structure ST based on the vehicle identification result, which is the result of the identification of the vehicle TR. Further, the communication circuit 125 transmits the measurement result determined to be used in the abnormality evaluation process to the host system 200. In this case, the processor 220 may carry out the abnormality evaluation process from which step S20 described above is omitted on the measurement result received from the communication circuit 125.

Measurement results from which a measurement result unsuitable for the abnormality evaluation process is excluded can thus be transmitted to the host system 200, whereby the accuracy of the evaluation of the soundness of the structure ST can be improved with the processing burden on the host system 200 reduced.

Since the sensing apparatuses 100 are driven by a battery and performs communication in compliance with the LPWA communication standard as described above, receipt of the operation information imposes a large power consumption burden. In view of the fact described above, the operation information can be acquired, for example, by coupling the sensing apparatuses 100 to a commercial power supply.

As described above, the physical quantity measurement method according to the present embodiment acquires a plurality of measurement results corresponding to the passage of a plurality of vehicles based on the measurement performed by a sensor for physical quantity computation attached to a structure through which the plurality of vehicles pass. Further, the physical quantity measurement method identifies the vehicle corresponding to each of the plurality of measurement results based on measurement time information that is information on the time when the measurement is performed and operation information that is information on the operation status of the vehicle. The physical quantity measurement method then determines whether or not to use each of the plurality of measurement results in an abnormality evaluation process of evaluating abnormality of the structure based on a vehicle identification result that is the result of the identification of the vehicle.

A measurement result unsuitable for the abnormality evaluation process of evaluating abnormality of the structure can thus be excluded, whereby the accuracy of the evaluation of the soundness of the structure performed by the abnormality evaluation process can be improved.

The physical quantity measurement method according to the present embodiment may carry out the process of computing a physical quantity representing displacement of the structure due to the passage of each of the vehicles as the measurement result based on the output of measurement data from the sensor and may carry out the abnormality evaluation process based on the physical quantity.

Information or the like that serves as an index representing whether or not abnormality has occurred in the structure can thus be provided as the measurement result.

In the physical quantity measurement method according to the present embodiment, when the vehicle corresponding to any of the measurement results is identified as a vehicle of a predetermined type, the abnormality evaluation process may not be carried out based on the measurement result.

Therefore, when the vehicle corresponding to the measurement result is identified as a vehicle of the predetermined type, the measurement result can be excluded as a measurement result unsuitable for the abnormality evaluation process, whereby the accuracy of the evaluation of the soundness of the structure can be improved.

In the physical quantity measurement method according to the present embodiment, when the vehicle corresponding to any of the measurement results is identified as the first type vehicle, the abnormality determination process may not be carried out based on the measurement result.

Therefore, when the vehicle corresponding to the measurement result is identified as the first type vehicle, the measurement result can be excluded as a measurement result unsuitable for the abnormality evaluation process, whereby the accuracy of the evaluation of the soundness of the structure can be improved.

In the physical quantity measurement method according to the present embodiment, when the vehicle corresponding to any of the measurement results is identified as the second type vehicle, the abnormality evaluation process may be carried out based on the measurement result.

Only measurement results suitable for the abnormality evaluation process can thus be accumulated, whereby the accuracy of the evaluation of the soundness of the structure can be improved.

In the physical quantity measurement method according to the present embodiment, passage time information representing the time when any of the vehicles passes through the structure may be estimated based on the operation information, and the vehicle corresponding to the measurement result may be identified based on the measurement time information and the passage time information.

Since the vehicle corresponding to the measurement result can thus be identified, whether or not the measurement result is caused to undergo the abnormality evaluation process can be evaluated, whereby the accuracy of the evaluation of the soundness of the structure can be improved.

In the physical quantity measurement method according to the present embodiment, time information for correction may be acquired before the sensor starts the measurement, and each of the measurement results may be acquired based on the time corrected by the time information for correction.

The error produced by the clocking performed by the clocking circuit can be reduced before the sensor starts the measurement, whereby the deviation between the measurement time information and the estimated time can be reduced.

The physical quantity measurement method according to the present embodiment may store estimated vehicle weight information that is information that associates the vehicle with an estimated weight of the vehicle, identify the estimated vehicle weight information corresponding to the measurement result based on the vehicle identification result, and carry out the abnormality evaluation process based on the identified estimated vehicle weight information and the measurement result.

Whether or not the measurement result is suitable for the abnormality evaluation process can thus be evaluated based on the estimated vehicle weight, which directly affects the measurement sensitivity.

The measurement system according to the present embodiment relates to a measurement system including a measurement section and a determination section. The measuring section acquires a plurality of measurement results corresponding to the passage of a plurality of vehicles based on the measurement performed by a sensor for physical quantity computation attached to a structure through which the plurality of vehicles pass. The determination section identifies the vehicle corresponding to each of the plurality of measurement results based on measurement time information that represents the time when the measurement result is obtained and operation information that is information on the operation status of the vehicle and determines whether or not to use each of the plurality of measurement results in an abnormality evaluation process of evaluating abnormality of the structure based on a vehicle identification result that is the result of the identification of the vehicle.

The host system according to the present embodiment relates to a host system including a communication interface that communicates with a sensing apparatus and a processor. The sensing apparatus acquires a plurality of measurement results corresponding to the passage of a plurality of vehicles based on the measurement performed by a sensor for physical quantity computation attached to a structure through which the plurality of vehicles pass. The communication interface receives information that associates each of the measurement results with measurement time information representing the time when the measurement result is obtained. The processor identifies the vehicle corresponding to each of the plurality of measurement results based on the measurement time information and operation information that is information on the operation status of the vehicle and determines whether or not to use each of the plurality of measurement results in an abnormality evaluation process of evaluating abnormality of the structure based on a vehicle identification result that is the result of the identification of the vehicle.

The sensing apparatus according to the present embodiment relates to a sensing apparatus including a sensor for physical quantity computation attached to a structure through which a plurality of vehicles pass, a processing circuit, and a communication circuit that receives operation information representing the operation status of the vehicles. The processing circuit acquires a plurality of measurement results corresponding to the passage of the plurality of vehicles based on the measurement performed by the sensor and identifies the vehicle corresponding to each of the plurality of measurement results based on measurement time information representing the time when the measurement result is obtained and operation information that is information on the operation status of the vehicle. The processing circuit further determines whether or not to use each of the plurality of measurement results in an abnormality evaluation process of evaluating abnormality of the structure based on a vehicle identification result that is the result of the identification of the vehicle. The communication circuit transmits the measurement result determined to be used in the abnormality evaluation process to the host system.

The present embodiment has been described above in detail, and a person skilled in the art will readily appreciate that a large number of variations are conceivable to the extent that they do not substantially depart from the novel items and effects of the present disclosure. Such variations are all therefore assumed to fall within the scope of the present disclosure. For example, a term described at least once in the specification or the drawings along with a different term having a broader meaning or the same meaning can be replaced with the different term anywhere in the specification or the drawings. Further, all combinations of the present embodiment and the variations fall within the scope of the present disclosure. Moreover, the configurations and other factors of the physical quantity measurement method, the measurement system, the host system, the sensing apparatus, and the like are not limited to those described in the present embodiment, and a variety of changes can be made thereto.

What is claimed is:

1. A physical quantity measurement method comprising:
acquiring a plurality of measurement results corresponding to passage of a plurality of vehicles based on measurement performed by a sensor for physical quantity computation attached to a structure through which the plurality of vehicles pass;
identifying the vehicle corresponding to each of the plurality of measurement results based on measurement time information that is information on time when the measurement is performed and operation information that is information on an operation status of the vehicle; and
determining whether or not to use each of the plurality of measurement results in an abnormality evaluation process of evaluating abnormality of the structure based on a vehicle identification result that is a result of the identification of the vehicle.

2. The physical quantity measurement method according to claim 1, further comprising:
carrying out the process of computing a physical quantity representing displacement of the structure due to the passage of each of the vehicles as the measurement result based on an output of measurement data from the sensor; and
carrying out the abnormality evaluation process based on the physical quantity.

3. The physical quantity measurement method according to claim 1,
wherein when the vehicle corresponding to any of the measurement results is identified as a vehicle of a predetermined type, the abnormality determination process is not carried out based on the measurement result.

4. The physical quantity measurement method according to claim 3,
wherein when the vehicle corresponding to any of the measurement results is identified as a first type vehicle, the abnormality determination process is not carried out based on the measurement result.

5. The physical quantity measurement method according to claim 4,
wherein when the vehicle corresponding to any of the measurement results is identified as a second type vehicle, the abnormality evaluation process is carried out based on the measurement result.

6. The physical quantity measurement method according to claim 1,
wherein passage time information representing time when any of the vehicles passes through the structure is estimated based on the operation information, and
the vehicle corresponding to the measurement result is identified based on the measurement time information and the passage time information.

7. The physical quantity measurement method according to claim 1,
wherein time information for correction is acquired before the sensor starts the measurement, and
the measurement results are each acquired based on time corrected by the time information for correction.

8. The physical quantity measurement method according to claim 1, further comprising:
storing estimated vehicle weight information that is information that associates each of the vehicles with an estimated weight of the vehicle;
identifying the estimated vehicle weight information corresponding to the measurement result based on the vehicle identification result; and
carrying out the abnormality evaluation process based on the identified estimated vehicle weight information and the measurement result.

9. A measurement system comprising:
a measurement section that acquires a plurality of measurement results corresponding to passage of a plurality of vehicles based on measurement performed by a sensor for physical quantity computation attached to a structure through which the plurality of vehicles pass; and
a determination section that identifies the vehicle corresponding to each of the plurality of measurement results based on measurement time information that represents time when the measurement result is obtained and operation information that is information on an operation status of the vehicle and determines whether or not to use each of the plurality of measurement results in an abnormality evaluation process of evaluating abnormality of the structure based on a vehicle identification result that is a result of the identification of the vehicle.

10. A host system comprising:
a communication interface that communicates with a sensing apparatus; and
a processor,
wherein the sensing apparatus acquires a plurality of measurement results corresponding to passage of a plurality of vehicles based on measurement performed by a sensor for physical quantity computation attached to a structure through which the plurality of vehicles pass,
the communication interface receives information that associates each of the measurement results with measurement time information representing time when the measurement result is obtained, and
the processor identifies the vehicle corresponding to each of the plurality of measurement results based on the measurement time information and operation information that is information on an operation status of the vehicle and determines whether or not to use each of the plurality of measurement results in an abnormality evaluation process of evaluating abnormality of the structure based on a vehicle identification result that is a result of the identification of the vehicle.
